(19) United States
(12) Patent Application Publication
(10) Pub. No.: US 2008/0134738 A1
(43) Pub. Date: Jun. 12, 2008

(54) USE OF HUMECTANTS IN FOLIAR NITROGEN CONTAINING FERTILIZER FORMULATIONS

(75) Inventors: Johnnie R. Roberts, Arlington, TN (US); Gregory C. Volgas, Bartlett, TN (US)

Correspondence Address: Connolly Bove Lodge & Hutz LLP, 1007 North Orange Street, P.O. Box 2207, Wilmington, DE, 19899-2207, US

(73) Assignee: HELENA HOLDING COMPANY, Wilmington, DE (US)

(21) Appl. No.: 11/950,974

(22) Filed: Dec. 5, 2007

Related U.S. Application Data
(60) Provisional application No. 60/868,811, filed on Dec. 6, 2006.

(51) Int. Cl. C05C 9/00

(52) U.S. Cl. 71/30; 71/28

(57) ABSTRACT

A fertilizer composition containing a urea-aldehyde polymer and boric acid wherein said boric acid is not in its salt form.

### RELATED APPLICATION

This application claims benefit to U.S. Provisional application No. 60/868,811 filed Dec. 6, 2006 which is incorporated by reference in its entirety for all useful purposes.

### BACKGROUND OF THE INVENTION

Fertilizer is often applied as a formulated (N-P-K) solid, granular or powder, or sometimes as a liquid to an area to be fertilized. There are basically two types of fertilizers, water soluble fertilizers and “slow release” fertilizers. While water soluble fertilizers are generally less expensive than slow release fertilizers, they have the disadvantage of leaching nutrients very quickly into and through the soil. Some solid, water soluble fertilizers can be made slow release by various coatings. Alternatively, a reduction in nitrogen availability also can be obtained by using enzyme inhibitors. Slow release fertilizers are designed to release nutrients to plants or soil over an extended period of time, which is more efficient than multiple applications of water soluble fertilizers. Therefore, slow release fertilizers (also referred to as controlled release or extended release) minimize the frequency with which plants must be fertilized, as well as reduce or minimize leaching.

Several prior patents have described various urea-formaldehyde compositions, methods of their manufacture, and their use as controlled release fertilizers. U.S. Pat. No. 6,306,194 (Wertz, et. al.) describes a method of manufacture for a controlled release liquid urea-formaldehyde fertilizer which has a nitrogen level greater than about 31%.

Several patents issued to Hawkins describe the preparation of urea-formaldehyde resins having high triazone contents. U.S. Pat. No. 4,554,005 (Hawkins) describes a reaction that produces at least about 30% triazone and has a preferred urea, formaldehyde, ammonia ratio of 1.2/1.0/0.28. U.S. Pat. No. 4,599,102 (Hawkins) describes a reaction that produces at least about 30% triazone and has a urea, formaldehyde, ammonia ratio of 1.2/1.0/0.5. Both of these resins have a high percentage of ammonia. U.S. Pat. No. 4,776,879 (Hawkins, et. al.) describes a reaction that produces at least about 75% triazone in water insoluble forms. This material is then crystallized out and redissolved at low solids levels for use. U.S. Pat. No. 4,778,510 (Hawkins) describes a reaction that produces at least about 48% triazone. Nitrogen release from triazone is extremely slow, therefore, methylolated urea is preferred. The nitrogen is the useful part of the fertilizer to the plant and thus the higher the % of nitrogen, the more efficient the fertilizer.

Other patents describe condensing the resin into small chains. U.S. Pat. No. 4,781,749 (Moore) reacts 1.5 to 2.5 mols formaldehyde per mole of urea in the presence of ammonium compounds such as ammonia. This initial mole ratio is below the initial mole ratio of 5 to 4 mols formaldehyde per mole of urea of the present invention. The pH is maintained at near neutral conditions (6.9-8.5) throughout the reaction. Condensed UF chains have lower solubility than methylolated ureas and could continue to advance, leading to extremely slow release.

U.S. Pat. No. 3,970,625 (Moore, et al.) describes a process for preparing urea-formaldehyde concentrates for use as slow release fertilizers or as adhesives. Urea and formaldehyde are mixed in a molar ratio of 1/4.4-7.3 with no more than 0.015 wt. % of ammonia present in the urea. The pH is adjusted to 8.8-9.5 and the mixture is heated to 50-60 degree. C. for 30-60 minutes. Thereafter, water is removed by distillation under reduced pressure until solids comprise 60-90% of the remaining residue. For producing fertilizers, the residue is heated for another 48 hours at a temperature of 45-50 degree. C.

U.S. Pat. No. 5,449,394 (Moore) relates to liquid non-polymeric controlled-release nitrogen plant food compositions containing the condensation products of one part ammonia, two parts urea and three parts formaldehyde at a base buffered pH slightly above 7. The reaction is accomplished at a temperature of about 100 degree. C. for 30-300 minutes. Water may be removed by evaporation until the nitrogen content of the formulation is between 20 and 30%. The solution is cooled before polymerization producing chains of more than 3 urea moieties can occur.

Urea-aldehyde fertilizer compositions typically contain some free urea and higher levels of the methylene urea which is the controlled release portion of the nitrogen. (Note: the terms urea-aldehyde, methylene urea, and triazone are used synonymously in this application). Many commercially available formulations actually dilute the controlled release portion of these reacted fertilizers with more urea or other nutrients. One of the key features of these blends where there are higher levels of methylene urea is that the spray deposits remain in the liquid form after application to plants. When the methylene urea is diluted back and provides roughly 50% or less of the total nitrogen, the spray deposits no longer retain this property of remaining liquid. They tend to crystallize on plant surfaces and this inhibits the uptake of the nitrogen. The nitrogen is still in the controlled release form of the original methylene urea, but it can be trapped in the crystals of the other nutrients.

The addition of acids to urea-aldehyde fertilizer compositions is discouraged due to problems with sedimentation. It is believed that acids will “turn on” the reaction of the polymer and that this further reaction will create long chain polymers that are no longer water soluble.

Boric acid has been used in conjunction with solid forms of urea-aldehyde fertilizer compositions before. U.S. Pat. No. 6,826,866 (Moore, et. al.) describes novel surfactant-impregnated, water-soluble fertilizer compositions which form dry, flowable products that are readily soluble and disperse easily in water. However, there are significant advantages for applicators in terms of ease of use, ease of application, and compatibility with other spray mixture constituents that encourage applicators to use liquid forms of fertilizers.

For the reasons stated above, when boron is used with liquid urea-aldehyde formulations, sodium borate has been the source. The label for Helena Chemical Company's Coron 25-0-0 plus 0.5% Boron lists borax pentahydrate as the source for boron. The chemical formula for this ingredient is Na₂B₄O₇.5H₂O. Tessenderloo Kerley's product Tri-Sert-CB 26-0-0 claims 0.5% boron on their label derived from disodium octaborate. Nachur's Fortified CRN MSDS sheet claims to contain urea-triazone and sodium borate.

It is a characteristic of the sodium borate formulations described above to form crystals and sediment when they are exposed to extreme cold (40° F. and below). Upon re-warming these mixtures to 70° F., the sediment and crystals do not readily re-dissolve or re-suspend. This makes these formulations unusable.

Boric acid has also been combined with urea-aldehyde fertilizers after it has been reacted with mono-ethanolamine. Helena Chemical produces such a product under the name Coron 12-0-0 with 5% boron. In this formulation, the boric acid is reacted with mono-ethanolamine prior to coming into direct contact with the urea-formaldehyde fertilizer blend. By reacting the boric acid and mono-ethanolamine, the pH of the resulting salt is brought to over 8.0. This overcomes the normal warning against adding an acid to urea-aldehyde fertilizers. In this case, boric acid is actually no longer present in it's pure form, but rather as a salt.

### A BRIEF SUMMARY OF THE INVENTION

The invention is directed to a fertilizer composition comprising a urea-aldehyde polymer and boric acid wherein said boric acid is not in its salt form.

The invention is also related to a method of applying the fertilizer to plants.

Whenever the term “% by weight” is used in the specification, it is understood that it means percent of the component per the total weight of the composition unless otherwise specified

### DESCRIPTION OF THE INVENTION

This invention relates to a nitrogen containing urea aldehyde fertilizer suitable for foliar application to desirable plants which further comprises boric acid that will prevent crystallization of active ingredients. The compositions described herein are normally, but not always, mixed with water or other fertilizers and applied through spray apparatus to actively growing plants.

Preferably if the composition is sprayed onto living plants, it will be sprayed on at the rate of 1 quart to 5 gallons per acre in a spray solution containing 1 to 100 gallons of water and/or other fertilizers.

It has been surprisingly discovered that the addition of pure boric acid to urea-aldehyde fertilizer blends can prevent the cold temperature crystallization and thus enhance the storage stability of the fertilizer blends. Unlike prior use of acid, the current discovery does not require the further addition of amines to form salts.

The urea-aldehyde fertilizers of the present invention include but are not limited to urea-formaldehyde formulations, also known as triazone or methylene urea formulations. The controlled release nitrogen formulations can further contain added urea, or other forms of added nitrogen. They can also contain other macronutrients or micronutrients.

The fertilizer composition has at least 10% of the nitrogen is derived from urea-aldehyde polymers, preferably at least 20% of the nitrogen is derived from urea-aldehyde polymers, more preferably at least 30% of the nitrogen is derived from urea aldehyde polymers, even more preferably at least 40% of the nitrogen is derived from urea-aldehyde polymers, more preferably at least 50% of the nitrogen is derived from urea-aldehyde polymers, more preferably at least 60% of the nitrogen is derived from urea-aldehyde polymers and most preferably at least 70% of the nitrogen is derived from urea-aldehyde polymers.

The further added nitrogen forms useful for this invention include urea, ammonium nitrate, ammonium phosphate, ammonium, and nitrate forms of nitrogen.

The macronutrients useful in this application are phosphate (P2O5) and potash (K2O) containing compositions. The phosphate can be derived from ammonium phosphates, potassium phosphates, phosphoric acid or any other phosphate fertilizer source as found in the Official Publication of the Association of American Plan Food Control Officials (AAPFCO). The potash can be derived form potassium chloride (muriate of potash), potassium sulfate, potassium nitrate, or any other potash fertilizer source as found in the Official Publication of the Association of American Plan Food Control Officials (AAPFCO).

Examples of other fertilizers that can be mixed with the inventive fertilizer are as follows: (c) Optionally other components.

The fertilizer composition optionally contains surfactants or solvents. The surfactants can be the surfactants disclosed in McCutcheon's Emulsifiers and Detergents, North American Edition, 2000. For example, useful surfactants or solvents include but are not limited to:

Alcohol alkoxylates including but not limited to:

Based on branched and linear alcohols

Those containing ethylene oxide or propylene oxide

Alcohol alkoxylate sulfates,

Alkylphenol alkoxylates including but not limited to:

Nonylphenol and octylphenols.

Those containing ethylene oxide or propylene oxide

Alkanolamides,

Alkylaryl sulfonates,

Amine oxides,

Amines including but not limited to:

Fatty amine alkoxylates such as but not limited to tallowamine alkoxylates,

Betaine derivatives,

Block polymers of ethylene and propylene glycol,

Carboxylated alcohol or alkylphenol alkoxylates,

Diols, including but not limited to Butanediols,

Diphenyl sulfonate derivatives,

Ethers, including but not limited to

Butyl celluslove,

Butyl carbitol,

Ethoxylated amines,

Ethoxylated fatty acids,

Ethoxylated fatty esters and oils,

Ethylene carbonate,

Fatty esters,

Glycerol esters,

Glycols including but not limited to

Propylene glycol,

Ethylene glycol,

Dipropylene glycol,

Diethylene glycol,

Phosphate ester surfactants including but not limited to

Phosphate esters of alcohol alkoxylates,

Phosphate esters of alkylphenol alkoxylates,

Propylene Carbonate,

Sarcosine derivatives,

Silicone-based surfactants,

Sorbitan derivatives including but not limited to:

Sorbitan esters,

Alkoxylated sorbitan esters,

Sucrose and glucose derivatives including but not limited to:

Alkylpolyglucosides,

Sulfates and sulfonates of alkoxylated alkylphenols,

Sulfates of alcohols,

Tristyrylphenol Alkoxylates,

Other surfactants are disclosed in McCutcheon's Emulsifiers and Detergents, North American Edition, 2000.

The following patents and reference, which include several ingredients that can be used according to this invention, are incorporated by reference in its entirety for all useful purposes:

U.S. Pat. No. 5,741,502 entitled Homogeneous, essentially nonaqueous adjuvant compositions with buffering capability

U.S. Pat. No. 5,725,630 entitled Dry granular fertilizer blend and a method of fertilizing plants

U.S. Pat. No. 5,580,567 entitled Homogeneous, essentially nonaqueous adjuvant compostions with buffering capability

U.S. Pat. No. 5,393,791 entitled Homogeneous, essentially nonaqueous adjuvant compositions with buffering capability

U.S. Pat. No. 5,234,919 entitled Water soluble, highly active dimethoate formulations in an alcohol/ester solvent system

U.S. Pat. No. 5,178,795 entitled Homogeneous, essentially nonaqueous adjuvant combinations with buffering capability

U.S. Pat. No. 5,906,961 entitled Alkanolamide spreader-sticker surfactant combination

U.S. Pat. No. 5,877,112 entitled Agricultural formulation.

The present invention does not require surfactants (emulsifiers) to mix with water. The addition of surfactants is optional.

The micronutrients useful in this application are boron, zinc, sulfur, calcium, magnesium, manganese, iron, copper, or any other agronomical important minor nutrient. Normally, these micronutrients are used in the sulfate, nitrate or chloride forms, or in the chelated form such as EDTA chelates.

Exemplary formulations are shown below. In these examples, Coron 28-0-0 is a commercial urea-formaldehyde composition containing 19.6% controlled release nitrogen and 8.4% urea nitrogen for a total of 28.0% nitrogen. All weights are shown in percents.

The fertilizer composition is preferably not an adhesive.

The fertilizer composition preferably has a pH of greater than 8.0.

The fertilizer composition has nitrogen content of the fertilizer composition is at least 5%, preferably at least 10%, preferably at least 15%, more preferably at least 20, more preferably at least 25% and most preferably at least 30%.

In the examples shown below, Coron 28-0-0 is a urea-formaldehyde polymer composition containing 70% of it's available nitrogen in the control release form and 30% of it's available nitrogen in the free urea form. Coron 28-0-0 contains 28% total nitrogen.

### EXAMPLE 1

| Ingredients: | % by weight in formula |
|---|---|
| Water | 29.96 |
| Urea | 34.30 |
| Coron 28-0-0 | 33.30 |
| Solubor powder (20.5% B) | 2.44 |
| Total | 100.00 |

### EXAMPLE 2

| Ingredients: | % by weight in formula |
|---|---|
| Water | 29.54 |
| Urea | 34.30 |
| Coron 28-0-0 | 33.30 |
| Boric acid (17.5% B) | 2.86 |
| Total | 100.00 |

Example 1 is an example of a control formulation wherein the boron content was derived from sodium borate.

Example 2 is an example of the invention wherein the boron content was derived from boric acid.

In storage at −12° F., Example 1 showed crystals after 1 week. After 1 week at ambient temperatures (70-75° F.) the sediment has not re-dissolved. Example 2 in storage at −12° F. also showed crystals after 1 week. However, after 24 hours at ambient temperatures (70-75° F.), this sample was free of crystals.

Other examples of the present invention are shown below:

### EXAMPLE 3

| Ingredients | % by weight in formula |
|---|---|
| Water | 54.02 |
| Urea | 13.98 |
| Potassium chloride | 16.39 |
| Coron 28-0-0 | 12.75 |
| Boric acid (17.5% B) | 2.86 |
| Total | 100.0 |

### EXAMPLE 4

| Ingredients: | % by weight in formula |
|---|---|
| Water | 26.69 |
| Urea | 34.30 |
| Coron 28-0-0 | 33.30 |
| Boric acid (17.5% B) | 5.71 |
| Total | 100.00 |

Each of these example formulations are added to water at the rate of about 1 quart to 5 gallons of the formulation in 5 gallons to about 100 gallons of water. This spray solution is then sprayed onto growing plants and used as fertilizer. Alternatively, the spray solution can be directly applied to soil. The pH of each of these solutions is above 8.0.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

We claim:

1. A fertilizer composition comprising a urea-aldehyde polymer and boric acid wherein said boric acid is not in its salt form.

2. The composition of claim 1 wherein the urea-aldehyde polymer is the product of a reaction of urea and formaldehyde.

3. The fertilizer composition of claim 1 wherein at least 10% of the nitrogen is derived from urea-aldehyde polymers.

4. The fertilizer composition of claim 1 wherein at least 20% of the nitrogen is derived from urea aldehyde polymers.

5. The fertilizer composition of claim 1 wherein at least 30% of the nitrogen is derived from urea-aldehyde polymers.

6. The fertilizer composition of claim 1 wherein at least 40% of the nitrogen is derived from urea aldehyde polymers.

7. The fertilizer composition of claim 1 wherein at least 50% of the nitrogen is derived from urea-aldehyde polymers.

8. The fertilizer composition of claim 1 wherein at least 60% of the nitrogen is derived from urea-aldehyde polymers.

9. The fertilizer composition of claim 1 wherein at least 70% of the nitrogen is derived from urea-aldehyde polymers.

10. The fertilizer composition of claim 1 wherein the composition is not an adhesive.

11. The fertilizer composition of claim 1, wherein the composition has a pH of greater than 8.0.

12. The fertilizer composition of claim 1, which further comprises surfactants.

13. The fertilizer composition of claim 1, wherein the nitrogen content of the fertilizer composition is at least 5%.

14. The fertilizer composition of claim 1, wherein the nitrogen content of the fertilizer composition is at least 10%.

15. The fertilizer composition of claim 1, wherein the nitrogen content of the fertilizer composition is at least 15%.

16. The fertilizer composition of claim 1, wherein the nitrogen content of the fertilizer composition is at least 20%.

17. The fertilizer composition of claim 1, wherein the nitrogen content of the fertilizer composition is at least 25%.

18. The fertilizer composition of claim 1, wherein the nitrogen content of the fertilizer composition is at least 30%.

19. A method of fertilizing plants which comprises contacting a plant with a fertilizer composition comprising a urea-aldehyde polymer and boric acid wherein said boric acid is not in its salt form.

20. The method as claimed in claim 19, wherein said contacting is by spraying and said fertilizer composition is mixed with
a. water
b. a different fertilizer or
c. a mixture of water and a different fertilizer
prior to spraying on said plant.
